(19) United States
(12) Patent Application Publication
(10) Pub. No.: US 2014/0350866 A1
(43) Pub. Date: Nov. 27, 2014

(54) Method of Gap Closing in Nucleotide Sequence and Apparatus Thereof

(71) Applicants: Binghang Liu, Shenzhen (CN); Zhenyu Li, Shenzhen (CN); Yanxiang Chen, Shenzhen (CN); Yingrui Li, Shenzhen (CN); Jian Wang, Shenzhen (CN); Jun Wang, Shenzhen (CN); Huanming Yang, Shenzhen (CN)

(72) Inventors: Binghang Liu, Shenzhen (CN); Zhenyu Li, Shenzhen (CN); Yanxiang Chen, Shenzhen (CN); Yingrui Li, Shenzhen (CN); Jian Wang, Shenzhen (CN); Jun Wang, Shenzhen (CN); Huanming Yang, Shenzhen (CN)

(21) Appl. No.: 14/361,158

(22) PCT Filed: Nov. 29, 2011
(86) PCT No.: PCT/CN2011/083160

§ 371 Date: Aug. 1, 2014

(51) Int. Cl. G06F 19/16

(52) U.S. Cl. CPC G06F 19/16
USPC 702/20

(57) ABSTRACT

Provided is a method of gap closing in nucleotide sequence. The nucleic acid sequence comprises a first contig at one end of a gap in an unassembled region, and a second contig at the other end of the gap in the unassembled region. The method comprises: selecting reads having an overlap with one end of the first contig close to the gap as a set of reads for gap closing; selecting reads having a shortest overlap with the first contig in the set of reads for gap closing as a candidate read; determining whether reads having an overlapping length with the first contig shorter than an overlapping length between the candidate read and the first contig present in the set of reads for gap closing, and determining whether reads having no overlapping relationship with the candidate read present in the set of reads for gap closing; obtaining a result of presenting an extension conflict, and determining an unconfident candidate read, if reads having an overlapping length with the first contig shorter than an overlapping length between the candidate read and the first contig present in the set of reads for gap closing, reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing; reselecting the candidate read until obtaining a confident candidate read, if the candidate read is unconfident; connecting the confident candidate read to the first contig, to form a new first contig; determining whether one end of the new first contig close to the gap has an overlap with one end of the second contig close to the gap; performing the step of selecting the set of reads for gap closing on the basis of the new first contig, if the one end of the new first contig close to the gap has no overlap with the one end of the second contig close to the gap, wherein the first contig in the step of selecting the set of reads for gap closing is replaced with the new first contig; connecting the new first contig to the second contig to complete gap closing, if one end of the new first contig close to the gap has an overlap with one end of the second contig close to the gap.

### CROSS REFERENCE TO RELATED APPLICATION

This application is a Section 371 National Stage Application of International Application No. PCT/CN2011/083160, filed Nov. 29, 2011, and published as WO2013/078619 on Jun. 6, 2013, the entire content of which is incorporated herein by reference.

### FIELD

The present invention relates to the field of genetic engineering technology, particularly relates to a method of identifying an extension conflict and determining a confidence of a candidate read in nucleotide sequence assembly, and an apparatus thereof.

### BACKGROUND ART

In the field of gene sequencing, with a popularity of the Next-Generation sequencing technology, a cost for sequencing becomes increasingly reduced, which promotes whole genome sequencing to various species. The principle of the Next-Generation sequencing technology determines that a length of reads is pretty short. In specific implementation process, the reads only have approximately dozens of bases to a hundred of bases, which undoubtedly increases a difficulty during analyzing data obtained from sequencing.

When the data obtained from sequencing are subjected to analyzing, a genome assembly method is commonly used. The genome assembly method usually comprises: firstly ignoring repeat regions, then with an auxiliary of paired-end read (PE), determining a relationship of non-repeat regions. However, an unassembled region between the non-repeat regions usually forms a gap.

In prior art, using a Sanger sequence technology-based genome assembly method and a Next-Generation sequencer (such as Solexa)-based genome assembly method, the initial assembled genome always has a large number of the unassembled regions, which usually closely relate to repeat sequence. Gap-associated repeat sequences can be divided into tandem repeat sequence and transponson repeat sequence. Procedures for gap closure in the prior art can accurately handle simple transponson repeat sequence, but have difficulties in handling long tandem repeat sequence.

From the angle of assembly method, there are mainly two methods for resolving the problem of the long tandem repeat sequence, one method is an overlapping-based local assembly, the other one is a De bruijn image-based local assembly.

The overlapping-based local assembly has difficulties in accurately identifying a conflict site caused by the repeat sequence, which then easily results in Indel.

While the De bruijn image-based local assembly can identify the conflict site caused by the repeat sequence, however, it is difficult to resolve the conflict, which needs disconnection, so as to affect the mount of gap closure.

Obviously, the above two method both have difficulties in dealing with the long tandem repeat sequence.

From the angle of assembly tool, there are mainly two programs for gap closure, respectively corresponding to a Gapcloser program of the overlapping-based local assembly method, and a SOAPdenovo program of the De Bruijn image-based local assembly method.

However, the above two programs both have disadvantages:

Firstly: the gap closure software Gapcloser is a partial assembly based on an overlap relationship in reads. Without considering complexity inside the gap, it easily leads to handle a complex gap with errors, which reduces an overall accuracy. In addition, having characteristics of large memory consumption and time consumption, Gaclosurer is not suitable for primary gap closing with a large genome.

Secondly, gap closing steps of SOAPdenovo assembly software all secondary assembly within a gap region based on De bruijin image. Although it may effectively solve a gap having a short length, the amount of gap being close is limited.

### SUMMARY

The major technical problem solved by the present disclosure is to provide a method of gap closing in a nucleic acid sequence, and an apparatus thereof, which may effectively identify the extension conflict during gap closing of a nucleic acid sequence.

To solve the above technical problem, one technical solution of the present disclosure is: providing a method of gap closing in a nucleic acid sequence, wherein the nucleic acid sequence comprises a first contig at one end of a gap of an unassembled region, a second contig at the other end of the gap of the unassembled region. According to the embodiments the present disclosure, the method may comprise:

selecting reads having an overlap with one end of the first contig close to the gap as a set of reads for gap closing;

selecting reads having a shortest overlap with the first contig in the set of reads for gap closing as a candidate read;

determining whether reads having an overlapping length with the first contig shorter than an overlapping length between the candidate read and the first contig present in the set of reads for gap closing, and determining whether reads having no overlapping relationship with the candidate read present in the set of reads for gap closing;

obtaining a result of presenting an extension conflict, and determining an unconfident candidate read, if reads having an overlapping length with the first contig shorter than an overlapping length between the candidate read and the first contig present in the set of reads for gap closing, reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing;

reselecting the candidate read until obtaining a confident candidate read, if the candidate read is unconfident;

connecting the confident candidate read to the first contig, to form a new first contig; determining whether one end of the new first contig close to the gap has an overlap with one end of the second contig close to the gap;

performing the step of selecting the set of reads for gap closing on the basis of the new first contig, if the one end of the new first contig close to the gap has no overlap with the one end of the second contig close to the gap, wherein the first contig in the step of selecting the set of reads for gap closing is replaced with the new first contig;

connecting the new first contig to the second contig to complete gap closing, if one end of the new first contig close to the gap has an overlap with one end of the second contig close to the gap.

According to embodiments of the present disclosure, after the step of reselecting the candidate read until obtaining a confident candidate read, and prior to the step of connecting the confident candidate read to the first contig to form a new first contig, the method further comprises:

determining whether the confident candidate read is the same read with the candidate read used in above-described method;

obtaining the result of presenting an extension conflict, and terminating the step of connecting the confident candidate read to the first contig, if the confident candidate read is the same read with the candidate read used in above-described method.

According to embodiments of the present disclosure, after the step of terminating the step of connecting the confident candidate read to the first contig, the method further comprises:

starting from one end of the second contig, performing the step of selecting reads having an overlap with one end of the second contig close to the gap as a set of reads for gap closing and the step of reselecting the candidate read until obtaining a confident candidate read on the basis of the second contig,

wherein the first contigs both in the step of selecting reads having an overlap with one end of the first contig close to the gap as a set of reads for gap closing and the step of reselecting the candidate read until obtaining a confident candidate read are replaced with the second contig.

According to embodiments of the present disclosure, the step of reselecting the candidate read until obtaining a confident candidate read comprises:

selecting reads having an overlapping length with the first contig longer than an overlapping length between the unconfident candidate read and the first contig, and shorter than an overlapping length between other reads in the set of reads for gap closing and the first contig as a newly-selected candidate read in the set of reads for gap closing;

determining whether the newly-selected candidate read has a 100% aligning rate to other reads in the set of reads for gap closing, and whether a fault tolerance of alignment is lower than a first threshold, whether an overlapping length with the first contig is longer than a second threshold;

taking the newly-selected candidate read as the confident candidate read to obtain the confident candidate read, if the newly-selected candidate read has a 100% aligning rate to other reads in the set of reads for gap closing, and a fault tolerance of alignment is lower than a first threshold, and an overlapping length with the first contig is longer than a second threshold;

performing the step of selecting reads having an overlapping length with the first contig longer than an overlapping length between the unconfident candidate read and the first contig, and shorter than an overlapping length between other reads in the set of reads for gap closing and the first contig in the set of reads for gap closing, if the newly-selected candidate read does not have a 100% aligning rate to other reads in the set of reads for gap closing, and a fault tolerance of alignment is not lower than a first threshold, an overlapping length with the first contig is not longer than a second threshold.

According to embodiments of the present disclosure, after the step of reselecting the candidate read until obtaining a confident candidate read, the method further comprises:

starting from one end of the second contig, performing the step of selecting reads having an overlap with one end of the second contig close to the gap as a set of reads for gap closing and the step of reselecting the candidate read until obtaining a confident candidate read on the basis of the second contig, if the confident candidate read is unable to be finally obtained after the step of reselecting the candidate read,

wherein the first contigs both in the step of selecting reads having an overlap with one end of the first contig close to the gap as a set of reads for gap closing and the step of reselecting the candidate read until obtaining a confident candidate read are replaced with the second contig.

According to embodiments of the present disclosure, the step of selecting reads having a shortest overlap with the first contig in the set of reads for gap closing as the candidate read comprises:

subjecting the reads for gap closing in the set of reads for gap closing to a short-similar-repeat treatment and identification. According to some specific examples, the step of subjecting the reads for gap closing in the set of reads for gap closing to a short-similar-repeat treatment and identification further comprises: selecting read for gap closing having a longer overlap as the candidate read, when a presence of the short-similar-repeat is identified.

According to embodiments of the present disclosure, after the step of selecting reads having a shortest overlap with the first contig in the set of reads for gap closing as the candidate read, the method further comprises:

determining whether the removed amount of reads in the set of reads for gap closing is greater than a third threshold during the extension of the candidate read;

abandoning the candidate read by a cyclic setting and reselecting the candidate read, if the removed amount of reads in the set of reads for gap closing is greater than a third threshold during the extension of the candidate read. According to some specific examples, the steps of abandoning the candidate read by a cyclic setting and reselecting the candidate read further comprise:

performing the step of selecting reads having a shortest overlap with the first contig in the set of reads for gap closing as the candidate read.

According to embodiments of the present disclosure, the step of selecting reads having a shortest overlap with the first contig in the set of reads for gap closing as the candidate read comprises:

subjecting the reads for gap closing in the set of reads for gap closing to a length filtering. According to some specific examples, the step of subjecting the reads for gap closing in the set of reads for gap closing to a length filtering further comprises:

selecting a short paired-end read within a gap region as the candidate read, selecting a long single-end read located at both ends of the gap as the candidate read.

According to embodiments of the present disclosure, the step of selecting reads having a shortest overlap with the first contig in the set of reads for gap closing as the candidate read comprises:

subjecting the reads for gap closing in the set of reads for gap closing to a position filtering. According to some specific examples, the step of subjecting the reads for gap closing in the set of reads for gap closing to a position filtering further comprises:

calculating a position of the reads for gap closing within the gap region based on paired-end relationship, and

subjecting the reads for gap closing to filtering based on the calculated position of the reads for gap closing within the gap region, to select the candidate read.

According to embodiments of the present disclosure, the step of connecting the new first contig to the second contig to complete gap closing, if one end of the new first contig close to the gap has an overlap with one end of the second contig close to the gap comprises:

performing the step of selecting reads having a shortest overlap with the first contig in the set of reads for gap closing as the candidate read, if the one end of the new first contig close to the gap prematurely overlaps with the one end of the second contig close to the gap based on a predicting length of the gap, and

selecting a non-overlapping read out of the set of reads for gap closing as the candidate read in the step of selecting reads having a shortest overlap with the first contig in the set of reads for gap closing as the candidate read.

According to embodiments of the present disclosure, the step of connecting the new first contig to the second contig to complete gap closing, if one end of the new first contig close to the gap has an overlap with one end of the second contig close to the gap comprises:

performing a sequence connection,

wherein the sequence connection comprises:

a direct connection between two contigs both without extensions,

a connection between the contig without extension and contig with extension; and

a connection between two contigs both with extensions.

According to embodiments of the present disclosure, before the step of performing a sequence connection, the method further comprises:

subjecting an accuracy of the sequence connection to a confidence determination during the step of sequence connection, wherein

the sequence connection is performed using a first confidence if the first confidence presents;

the sequence connection is performed using a second confidence if the first confidence does not present while the second confidence presents;

the sequence connection is performed using a third confidence if both the first confidence and second confidence do not present while a third confidence presents;

wherein

the first confidence refers connected two sequences not only having an overlap which are not repeat, but also supported by a span read;

the second confidence refers two sequences connected by a bridging read, and having no overlap;

the third confidence refers the connected two sequences having an overlap, without a proving support for the overlap region.

To solve the above technical solution, another technical solution provided by the present disclosure is to provide an apparatus for gap closing in a nucleic acid sequence. According to some embodiments of the present disclosure, the apparatus may comprise:

a first selecting module, configured to select reads having an overlap with one end of the first contig close to the gap as a set of reads for gap closing;

a second selecting module, configured to select reads having a shortest overlap with the first contig in the set of reads for gap closing as a candidate read;

a first determining module, configured to determine whether reads having an overlapping length with the first contig shorter than an overlapping length between the candidate read and the first contig present in the set of reads for gap closing, and whether reads having no overlapping relationship with the candidate read present in the set of reads for gap closing;

a second determining module, configured to obtain a result of presenting an extension conflict, and determine an unconfident candidate read, if the first determining module determines that reads having an overlapping length with the first contig shorter than an overlapping length between the candidate read and the first contig present in the set of reads for gap closing, or reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing;

a third selecting module, configured to reselect the candidate read until a confident candidate read is obtained, if the second determining module determines that the candidate read is unconfident;

a connecting module, configured to connect the confident candidate read to the first contig, to form a new first contig;

a third determining module, configured to determine whether one end of the new first contig close to the gap has an overlap with one end of the second contig close to the gap;

a cyclic module, configured to perform a function of the first selecting module again on the basis of the new first contig, if the third determining module determines that one end of the new first contig close to the gap has no overlap with the one end of the second contig close to the gap, wherein the first contig in the first selecting module is replaced with the new first contig;

a gap closing module, configured to connect the new first contig to the second contig to complete gap closing, if the third determining module determines that one end of the new first contig close to the gap has an overlap with one end of the second contig close to the gap.

According to embodiments of the present disclosure, the apparatus further comprises:

a fourth determining module, configured to determine whether the confident candidate read is the same read with the candidate read used in the above-described apparatus; after the third selecting module obtains the confident candidate read;

a terminating module, configured to obtain the result of presenting an extension conflict, and terminate operations of the connecting module, if the fourth determining module determines that the confident candidate read is the same read with the candidate read used in the above-described apparatus.

According to embodiments of the present disclosure, the apparatus further comprises:

a first gap reclosing module, configured to perform the first selecting module, the second selecting module and the third selecting module on the basis of the second contig, by starting from one end of the second contig, after the terminating module terminates operations of the connecting module, wherein the first contigs in the first selecting module, the second selecting module and the third selecting module are replaced with the second contig.

According to embodiments of the present disclosure, the third selecting module comprises:

a first selecting unit, configured to select reads having an overlapping length with the first contig longer than an overlapping length between the unconfident candidate read and the first contig, and shorter than an overlapping length between other reads in the set of reads for gap closing and the first contig as a newly-selected candidate read in the set of reads for gap closing;

a first determining unit, configured to determine whether the newly-selected candidate read has a 100% aligning rate to other reads in the set of reads for gap closing, and whether a fault tolerance of alignment is lower than a first threshold, whether an overlapping length with the first contig is longer than a second threshold;

an obtaining unit, configured to take the newly-selected candidate read as the confident candidate read, if the first determining unit determines that the newly-selected candidate read has a 100% aligning rate to other reads in the set of reads for gap closing, and a fault tolerance of alignment is lower than a first threshold, an overlapping length with the first contig is longer than a second threshold;

a second selecting unit, configured to perform the first selecting unit, if the first determining unit determines that the newly-selected candidate read does not have a 100% aligning rate to other reads in the set of reads for gap closing, and a fault tolerance of alignment is not lower than a first threshold, an overlapping length with the first contig is not longer than a second threshold.

According to embodiments of the present disclosure, the apparatus further comprises:

a second gap reclosing module, configured to successively perform the first selecting module, the second selecting module and the third selecting module on the basis of the second contig, by starting from one end of the second contig, if the third selecting module is unable to finally obtain the confident candidate read after reselecting the candidate read, wherein the first contigs in the first selecting module, the second selecting module and the third selecting module are replaced with the second contig.

According to embodiments of the present disclosure, the second selecting module is also configured to subject the reads for gap closing in the set of reads for gap closing to a short-similar-repeat treatment and identification.

According to some specific examples, the second selecting module is configured to select read for gap closing having a longer overlap as the candidate read, when a presence of the short-similar-repeat is identified.

According to embodiments of the present disclosure, the apparatus further comprises:

a fifth determining module, configured to determine whether the removed amount of reads in the set of reads for gap closing is greater than a third threshold during the extension of the candidate read, after the second selecting module has selected the candidate read;

a fourth selecting module, configured to abandon the candidate read by a cyclic setting and reselect the candidate read.

According to some specific examples, the fourth selecting module is configured to perform the second selecting module, if the fifth determining module determines that the removed amount of reads in the set of reads for gap closing is greater than a third threshold during the extension of the candidate read.

According to embodiments of the present disclosure, the second selecting module is also configured to subject the reads for gap closing in the set of reads for gap closing to a length filtering.

According to some specific examples, the second selecting module is configured to select a short paired-end read within a gap region as the candidate read, select a long single-end read located at both ends of the gap as the candidate read.

According to embodiments of the present disclosure, the second selecting module is also configured to subject the reads for gap closing in the set of reads for gap closing to a position filtering.

According to some specific examples, the second selecting module is configured to calculate a position of the reads for gap closing within the gap region based on paired-end relationship, subject the reads for gap closing to filtering based on the calculated position of the reads for gap closing within the gap region, to select the candidate read.

According to embodiments of the present disclosure, the gap closing module comprises:

a second determining unit, configured to determine whether the one end of the new first contig close to the gap prematurely overlaps with the one end of the second contig close to the gap based on a predicting length of the gap;

a third selecting unit, configured to perform the second selecting module, if the second selecting module determines that one end of the new first contig close to the gap prematurely overlaps with the one end of the second contig close to the gap based on a predicting length of the gap determined, wherein a non-overlapping read out of the set of reads for gap closing is selected as the candidate read when the second selecting module selects the candidate read.

According to embodiments of the present disclosure, the gap closing module is also configured to perform a sequence connection,

wherein the sequence connection comprises:

a direct connection between two contigs both without extensions,

a connection between the contig without extension and contig with extension; and

a connection between two contigs both with extensions.

According to embodiments of the present disclosure, the gap closing module is also configured to subject an accuracy of the sequence connection to a confidence determination during the step of sequence connection during performing the sequence connection, wherein

the sequence connection is performed using a first confidence if the first confidence presents;

the sequence connection is performed using a second confidence if the first confidence does not present while the second confidence presents;

the sequence connection is performed using a third confidence if both the first confidence and second confidence do not present while a third confidence presents,

wherein

the first confidence refers connected two sequences not only having an overlap which are not repeat, but also supported by a span read;

the second confidence refers two sequences connected by a bridging read, and having no overlap;

the third confidence refers connected two sequences having an overlap, without a proving support for the overlap region.

Advantageous effects of the present disclosure lie to: being different to the prior art, the method of the present disclosure comprises: firstly selecting reads having an overlap with one end of the first contig close to the gap, to form a set of reads for gap closing; secondly selecting reads having a shortest overlap with the first contig in the set of reads for gap closing as the candidate read. After the candidate read has been selected, if reads having an overlapping length with the first contig shorter than an overlapping length between the candidate read and the first contig present in the set of reads for gap closing, or reads having no overlapping relationship with the candidate read present in the set of reads for gap closing, an extension conflict will present. After the extension conflict presents, the present disclosure also comprises: reselecting the candidate read until obtaining a confident candidate read; connecting the confident candidate read to the first contig, to form a new first contig; determining whether one end of the new first contig close to the gap has an overlap with one end of the second contig close to the gap; repeating the above steps on the basis of the new first contig continuously if the one end of the new first contig close to the gap has no overlap with the one end of the second contig close to the gap; connecting the new first contig to the second contig to complete gap closing, if one end of the new first contig close to the gap has an overlap with one end of the second contig close to the gap. By the above method, the present disclosure may effectively identify the extension conflict during the gap closing of the nucleic acid sequence, which improves the accuracy of the gap closing.

### BRIEF DESCRIPTION OF THE DRAWINGS

FIG. 1 is a flow chart showing the method of gap closing in a nucleic acid sequence according to an embodiment of the present disclosure;

FIG. 2 is a schematic diagram showing a selection of a candidate read in a nucleic acid sequence according to an embodiment of the present disclosure;

FIG. 3 is a schematic diagram showing a connection during gap closing in a nucleic acid sequence according to an embodiment of the present disclosure;

FIG. 4 is a schematic diagram showing an identification of an extension conflict in a nucleic acid sequence according to an embodiment of the present disclosure;

FIG. 5 is a structural diagram showing an apparatus for gap closing in a nucleic acid sequence according to an embodiment of the present disclosure.

The definitions for some terms used herein are shown as below:

| | | |
|---|---|---|
| PE read | paired-end read | obtaining distance information of two ends and between |
| | | the two ends of a DNA sequence having a longer length |
| | | by a paired-end construction method, and obtaining |
| | | sequences of the two ends by sequencing |
| read | read | base sequence produced during sequencing |
| block | block | artificially selecting a nucleic acid sequence having a |
| | | certain length in the DNA sequence |
| contig | contig | one linear and orderly sequence constituted by a group of |
| | | reads |
| overlap | overlap | a same part between two sequences during a sequence |
| | | connection |
| kmer | kmer | a DNA sequence having a length of K, k usually is 17 |
| single read | single read | a kind of sequence information obtained mainly by a |
| | | Sanger-based sequencing method, namely, obtaining |
| | | sequence information of one end of long DNA sequence |
| | | or thoroughly sequenced information of short sequence by |
| | | means of Sanger sequencing method |
| scaffold | scaffold | a result of connecting contig by plasmid, BACs, mRNA, |
| | | or connection information of paired-end read from other |
| | | resource, in which the connections in the contigs are |
| | | orderly and directed |
| gap | gap | When the data obtained from sequencing are subjected to |
| | | analyzing, a genome assembly method is generally used. |
| | | The genome assembly method usually comprises: firstly |
| | | ignoring repeat regions, then with an auxiliary of |
| | | paired-end read (PE), determining a relationship of |
| | | non-repeat regions. While, an unassembled region |
| | | between the non-repeat regions usually forms a gap. |
| repeat | repeating | Nucleic acid sequence repeated appearing in the genome |
| | sequence | sequence |
| indel | insert/deletion | insert or deleting one sequence to change the structure of |
| | | DNA sequence |

### DETAILED DESCRIPTION

Reference will be made in detail to embodiments of the present disclosure combining with figures.

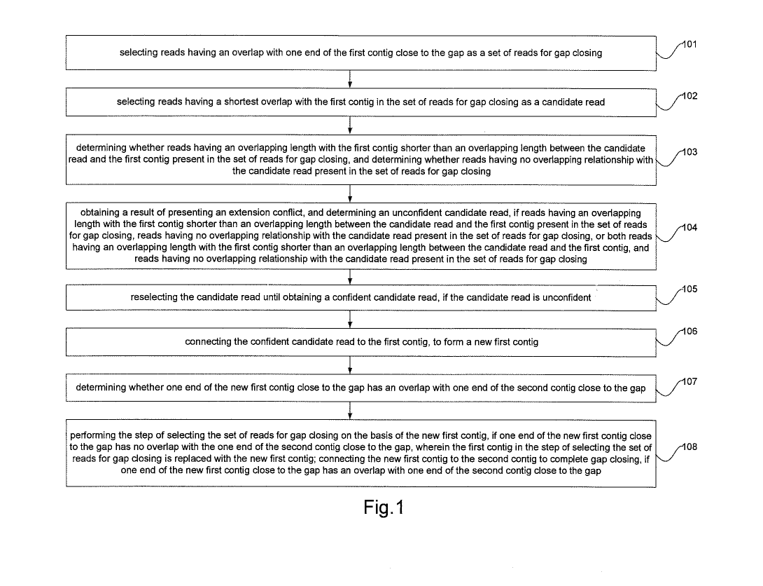

FIG. 1 is a flow chart showing the method of gap closing in a nucleic acid sequence according to an embodiment of the present disclosure. In the method, one end of a gap has a first contig, and the other one end of the gap has a second contig, which has been shown in FIG. 1, the method comprises:

step 101, selecting reads having an overlap with one end of the first contig close to the gap as a set of reads for gap closing;

step 102, selecting reads having a shortest overlap with the first contig in the set of reads for gap closing as the candidate read;

A method of selecting the candidate read is: firstly finding reads having an overlap with one end of the first contig close to the gap as a set of reads for gap closing; secondly selecting one read having a shortest overlap with the first contig in the set of reads for gap closing as the candidate read.

Another method of selecting the candidate read is: finding a nucleic acid sequence at one end of the first contig close to the gap as a node read; finding reads having an overlap with the node read as a set of reads for gap closing; thirdly selecting one read having a shortest overlap with the node read as the candidate read.

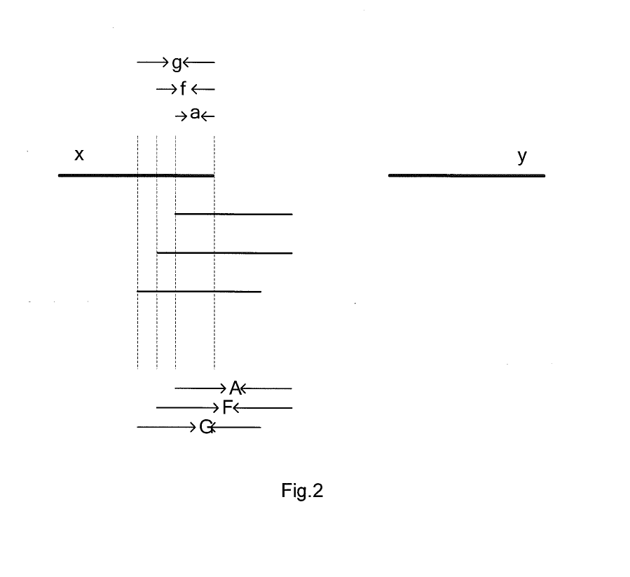

A specific method of selecting the candidate read is (shown in FIG. 2): the gap has a first contig x and a second contig y at both ends; A, F and G are reads having an overlap with one end of the first contig x close to the gap, respectively, selected from the set of reads for gap closing, which respectively having an overlapping length of a, f and g, in which the read A has a shortest overlapping length a with one end of the first contig x close to the gap, thus the read A is selected as a candidate read for sequence extension during gap closing. The reads having an overlap with one end of the first contig x close to the gap which are selected during gap closing comprise: selecting reads having an overlap with one end of the first contig close to the gap.

The method of selecting the candidate read is different as different cases, for example: subjecting the reads in the set of reads for gap closing to a short-similar-repeat treatment and identification, namely, selecting read for gap closing having a longer overlap as the candidate read, when a presence of the short-similar-repeat is identified. The short-similar-repeat is usually shorter than 50 bp, and has close positions, which leads to base deletion of the nucleic acid sequence within the gap region. When the short-similar-repeat is identified, reads having a longer overlap is preferably selected for sequence extension in an embodiment of the present disclosure, which may effectively avoid the problem of short-similar-repeat.

After the candidate read has been selected, whether the removed amount of reads in the set of reads for gap closing is greater than a third threshold during the extension of the candidate read is determined. The candidate read is abandoned by a cyclic setting and the candidate read is reselected, if the removed amount of reads in the set of reads for gap closing is greater than a third threshold during the extension of the candidate read. In specific implementing procedure, the third threshold is usually 67%, the original candidate read is abandoned by a cyclic setting and the candidate read is reselected, if 67% of the reads are abandoned from the set of reads for gap closing.

The reads for gap closing in the set of reads for gap closing are subjected to a length filtering, namely, a short paired-end read within a gap region is selected as the candidate read, a long single-end read located at both ends of the gap is selected as the candidate read, the single-end read usually overlaps with one end of the gap.

The reads for gap closing in the set of reads for gap closing are subjected to a position filtering, namely, a position of the reads for gap closing within the gap region is calculated based on paired-end relationship, the reads are subjected to filtering based on the calculated position of the reads for gap closing within the gap region, to select the candidate read. If the calculated position of the reads for gap closing within the gap region is pretty accurate, a condition of subjecting the reads for gap closing to a position filtering may be set more strictly.

According to a predicting length of the gap, if the one end of the new first contig close to the gap prematurely overlaps with the one end of the second contig close to the gap, the candidate read is abandoned and reselected, in which a non-overlapping read out of the set of reads for gap closing is selected as the candidate read when selecting candidate read, which may guarantee striding a repeating region once, however such treatment during gap closing only can present once.

step 103: determining whether reads having an overlapping length with the first contig shorter than an overlapping length between the candidate read and the first contig present in the set of reads for gap closing, and determining whether reads having no overlapping relationship with the candidate read present in the set of reads for gap closing;

step 104: obtaining a result of presence an extension conflict, and determining a presence of the candidate read, if reads having an overlapping length with the first contig shorter than an overlapping length between the candidate read and the first contig present in the set of reads for gap closing, reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing;

A reason of the unconfident candidate read resulting from the presence of a conflict is that the candidate read has a sequencing error itself, or an error read is selected as the candidate read by an error program. The major reason leading to the extension conflict is that the candidate read has an error itself, which may also result in another kind of conflict, for example, prior the reads for gap closing extends forward, reads which are selected as the candidate read used in the above-described method is selected as the candidate read for extension, which leads to a conflict of infinite loop extension within such range.

step 105, reselecting the candidate read until obtaining a confident candidate read, if the candidate read is unconfident;

The unconfident candidate read is abandoned, to reselect a candidate read.

Reads having an overlapping length with the first contig longer than an overlapping length between the unconfident candidate read and the first contig, and shorter than an overlapping length between other reads in the set of reads for gap closing, and the first contig as a newly-selected candidate read are selected in the set of reads for gap closing.

The standard for reselecting the candidate read is: determining whether the newly-selected candidate read has a 100% aligning rate to other reads in the set of reads for gap closing, and whether a fault tolerance of alignment is lower than a first threshold, whether an overlapping length with the first contig is longer than a second threshold. According to some embodiments of the present disclosure, the first threshold is 3%, the second threshold is 1 kmer, and however, the settings of such thresholds are not limited to the above, which may be adjusted as required. The newly-selected candidate read is regarded as being confident, which may be taken as the confident candidate read for the sequence extension, if the newly-selected candidate read has a 100% aligning rate to other reads in the set of reads for gap closing, and a fault tolerance of alignment is lower than a first threshold, an overlapping length with the first contig is longer than a second threshold.

The step of selecting reads having an overlapping length with the first contig longer than an overlapping length between the unconfident candidate read and the first contig, and shorter than an overlapping length between other reads in the set of reads for gap closing and the first contig is performed in the set of reads for gap closing, if the newly-selected candidate read does not have a 100% aligning rate to other reads in the set of reads for gap closing, or a fault tolerance of alignment is not lower than a first threshold, or an overlapping length with the first contig is not longer than a second threshold, or the newly-selected candidate read does not have a 100% aligning rate to other reads in the set of reads for gap closing and a fault tolerance of alignment is not lower than a first threshold, or the newly-selected candidate read does not have a 100% aligning rate to other reads in the set of reads for gap closing and an overlapping length with the first contig is not longer than a second threshold, or a fault tolerance of alignment is not lower than a first threshold and an overlapping length with the first contig is not longer than a second threshold, or the newly-selected candidate read does not have a 100% aligning rate to other reads in the set of reads for gap closing and a fault tolerance of alignment is not lower than a first threshold and an overlapping length with the first contig is not longer than a second threshold.

If the confident candidate read is unable to be finally obtained after the step of reselecting the candidate read, the sequence extension is abandoned, and steps 101 to 105 are performed on the basis of the second contig by starting from one end of the second contig, in which the first contigs in steps 101 to 105 are replaced with the second contigs, which avoids the conflict resulted from an error base of the candidate read.

The selected confident candidate read has following characteristics: other reads have an overlapping relationship with the first contig should have an overlap with the candidate read, and such overlap has a length longer than an overlapping length between the candidate read and the first contig.

A realization approach of the standard of selecting the candidate read described above is subjecting other reads having an overlapping relationship with one end of the first contig close to the gap to aligning to the candidate read. In an embodiment of the present disclosure, the alignment is performed by means of block gradual extension, however, the aligning ways in reads are not limited to the above described, which is not defined herein.

In an embodiment of the present disclosure, an overlapping length between other reads having an overlapping relationship with the first contig and the candidate read is obtained by means of block gradual extension, namely, one block from the candidate read is selected to set as one target read, whether bases within the block can be aligned to the target read is determined: if the bases within the block can be aligned to the target read, the block within the candidate read is moved forward one base, then bases within a forward-moved block are aligned to the target read, such alignment is repeated until obtaining no matching result. Then the length of the overlap between the candidate and the target read may be obtained. For such length, a second threshold needs to be set, to represent that the overlap between two reads does not come by change, if the overlap has a length longer than the second threshold, it represents that such candidate read is confident.

step 106, connecting the confident candidate read to the first contig, to form a new first contig;

After the confident candidate seed has been selected, the candidate read is connected to the first contig, to form a new first contig, by then, the candidate read is taken as one part of the new first contig for continuous extension.

step 107, determining whether one end of the new first contig close to the gap has an overlap with one end of the second contig close to the gap;

step 108, performing the step of selecting the set of reads for gap closing on the basis of the new first contig, if the one end of the new first contig close to the gap has no overlap with the one end of the second contig close to the gap, wherein the first contig in the step of selecting the set of reads for gap closing is replaced with the new first contig; connecting the new first contig to the second contig to complete gap closing, if one end of the new first contig close to the gap has an overlap with one end of the second contig close to the gap.

During gap closing in an embodiment of the present disclosure, it not only requires accurate assembly, but also requires accurate connection. The accurate assembly may not only guarantee decreasing an error rate of base, but also may guarantee accurate connection. While, the accurate connection directly determines whether indel presents or not. In addition, an error extension should be considered during connection. A relationship of the sequence connection according to embodiments of the present disclosure may be divided into following three confidences based on a connection quality:

1) a first confidence refers connected two sequences not only having an overlap which are not repeat, but also supported by a span read;

2) a second confidence refers two sequences connected by a bridging read, and having no overlap;

3) a third confidence refers connected two sequences having an overlap, without a support by an evidence.

The above three confidences may all present, and the first confidence has a highest quality, but does not mean certainly accurate; the second confidence has a higher quality, which also does not mean certainly accurate. Thus, the connection within the gap region in embodiments of the present disclosure should be classified to be particularly handled in accordance with the actual usage. The connections within the gap region may be divided into 3 types: a direct connection between two contigs both without extensions, a connection between the contig without extension and contig with extension; and a connection between two contigs both with extensions. In the cases of three types of connections, whether the three confidences present are determined, namely, if a first confidence presents, the sequencing connection is performed using the first confidence; if the first confidence does not present while a second confidence presents, the sequencing connection is performed using the second confidence; if both the first confidence and second confidence do not present while a third confidence present, the sequencing connection is performed using the third confidence.

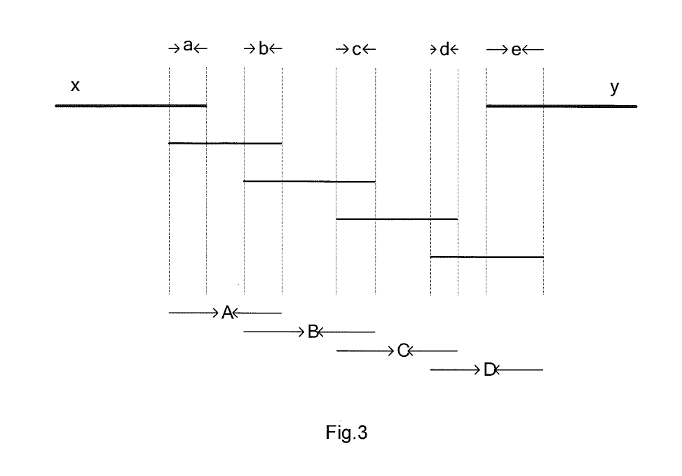

To explicitly explain how to perform gap closing in a sequence assembly, based on the above method, FIG. 3 shows a schematic diagram showing a connection during gap closing in a nucleic acid sequence according to an embodiment of the present disclosure. As shown in FIG. 3, the gap has a first contig x and a second contig y respectively at both ends; A, B, C and D is reads selected during gap closing sequence extension; a, b, c, d and e are overlapping lengths among reads respectively.

Firstly, the candidate read A for gap closing is selected from the set of reads for gap closing, which has a shortest overlap a with the first contig x; secondly, whether the candidate read A is confident is determined: if the candidate read A is confident, the confident candidate read A is connected to the contig x, to form a new first contig. Whether one end of the new first contig close to the gap has an overlap with one end of the second contig y close to the gap is determined: if one end of the new first contig close to the gap has no overlap with one end of the second contig y close to the gap, the candidate read B is selected on the basis of the new first contig continuously. A standard for selecting the candidate read B is also that the candidate read B has a shortest overlap b with the first new contig and is confident. Then the candidate read B is subjected to a sequence extension. And whether the candidate B has an overlap with one end of the second contig y close to the gap is also determined: if the candidate B has no overlap with one end of the second contig y close to the gap, the candidate read is selected continuously and subjected to the step of the sequence extension until the candidate read D which is subjected to the sequence extension has an overlap e with the second contig y, then the gap closing is completed and finished. During gap closing, the candidate reads required for the sequence extension are not limited to those shown in Figures; the number thereof may be any one of 1, 2, 3 . . . and n.

It should note that, the present disclosure is to identify the extension conflict during an overlap-based method of gap closing. The above described is to identify the extension conflict during one end of the gap is subjected to the sequence extension. The gap has the first contig at one end, and has the second contig at the other end. When selecting the candidate read for sequence extension within the gap and identifying the extension conflict, it may start from the first contig, or may start from the second contig, or may start from the first contig and the second contig simultaneously. In the case of one end of the gap cannot extent due to the extension conflict, it may start extension from the other end of the gap.

It may understand from the above that, being different from the prior art, the present disclosure firstly selects reads for gap closing having an overlap with one end of the first contig close to the gap, to form a set of reads for gap closing; secondly selects reads having a shortest overlap with the first contig in the set of reads for gap closing as the candidate read. After the candidate read has been selected, if reads having an overlapping length with the first contig shorter than an overlapping length between the candidate read and the first contig present in the set of reads for gap closing, or if reads having no overlapping relationship with the candidate read present in the set of reads for gap closing, an extension conflict presents. After the extension conflict has presented, the original unconfident candidate read is abandoned; the candidate read is reselected until an confident candidate read is obtained. The confident candidate read is connected to the first contig, to form a new first contig. Then whether one end of the new first contig close to the gap has an overlap with one end of the second contig close to the gap is determined, if one end of the new first contig close to the gap has no overlap with one end of the second contig close to the gap, the above step of selecting the set of reads for gap closing is performed on the basis of the new first contig continuously; if one end of the new first contig close to the gap has an overlap with one end of the second contig close to the gap, the new first contig is connected to the second contig to complete gap closing. By the above steps, the present disclosure may effectively identify the extension conflict in the nucleic acid sequence during gap closing, which may improve the accuracy of the gap closing.

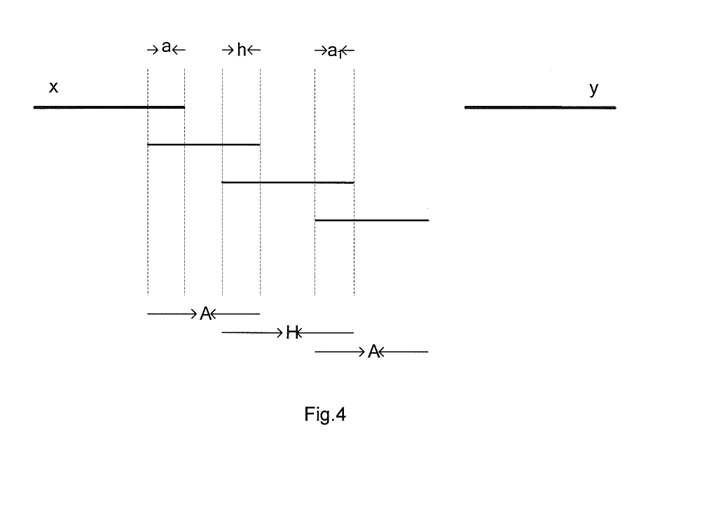

In other embodiments, methods of identifying an extension conflict comprise: during a gap closing sequence extents, regardless whether a newly-selected candidate read is confident, if the newly-selected candidate read is the candidate read selected in previous sequence extension, the extension conflict presents, which makes the extension of such sequence being in an infinite loop. Such conflict is solved by a method of terminating the sequence extension. FIG. 4 shows an identification of an extension conflict in a nucleic acid. As can be seen from FIG. 4, the gap has a first contig x and a second contig y at two ends respectively; A and H are the candidate reads respectively selected during gap closing sequence extents; a, h and a₁ are overlap lengths among reads respectively, in which a may be equal or not equal to a₁. During gap closing sequence extents, if the selected candidate read A is the candidate read A selected in previous sequence extension, an extension conflict presents, and the step of sequence extension is terminated. The newly-selected candidate read A may be at a distance of a plurality of reads with the candidate read A selected in previous sequence extension, or may be at without an interval of the candidate read with the candidate read A.

The reason for such conflict is the candidate read has a sequencing error or a repeat replication fork, in which the repeat replication fork results from a repeat problem of gap closing sequence. To improve the accuracy of gap closing, before gap closing, a position of read within the gap region is calculated based on paired-end relationship, and then the reads for gap closing is subjected to filtering based on the calculated position, which decreases the conflict resulted from a long sequence repeat. To guarantee the accuracy of the calculated position within the gap region, the filtering criteria for position may be set strictly.

In summary, there are two reasons for the extension conflict: one is that a base error presents in the candidate read; the other is that repeat replication folks present. If the sequencing error presents in the candidate read, a large amount of reads will be filtered out; and the repeat replication folks will lead to an infinite loop of the gap closing sequence within a certain sequence during extension, which decreases the accuracy of gap closing.

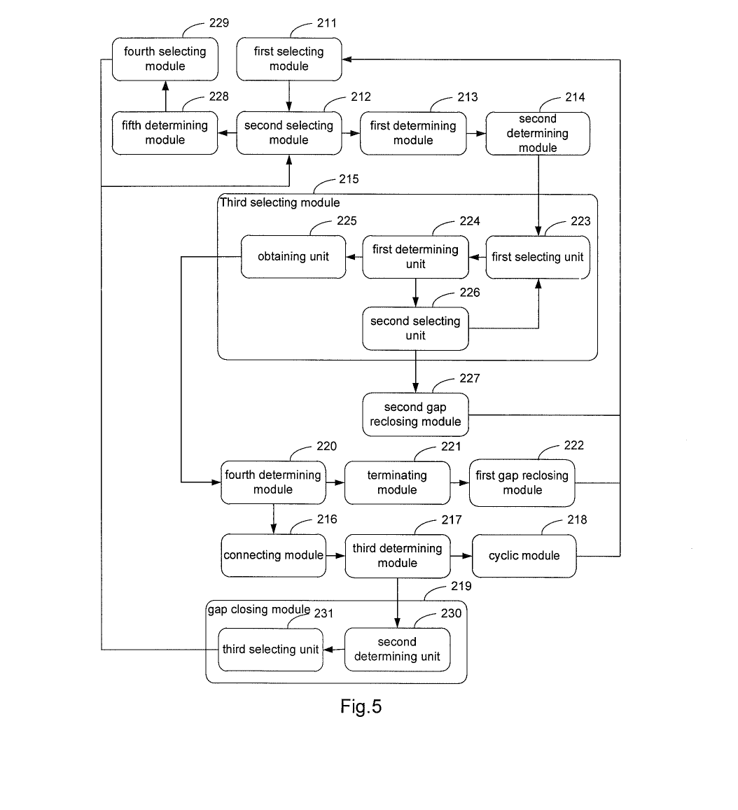

In order to identify the extension conflict, and guarantee the accuracy of read for gap closing as much as possible, a fault tolerance of alignment with a lower level needs to be set. During gap closing, a solution of avoiding the conflict presence is that the reads for gap closing is subject to a pretreatment of an error correction, which improves the quality of read and guarantees the accuracy of read at both ends. FIG. 5 is a structural diagram showing an apparatus for gap closing in a nucleic acid sequence according to an embodiment of the present disclosure. As shown in FIG. 4, the apparatus comprises:

a first selecting module 211, a second selecting module 212, a first determining module 213, a second determining module 214, a third selecting module 215, a connecting module 216, a third determining module 217, a cyclic module 218, a gap closing module 219, a fourth determining module 220, a terminating module 221, a first gap reclosing module 222, a second gap reclosing module 227, a fifth determining module 228, and a fourth selecting module 229. The third selecting module 215 comprises a first selecting unit 223, a first determining unit 224, an obtaining unit 225 and a second selecting unit 226. The gap closing module 219 comprises: a second determining unit 230 and a third selecting unit 231.

The first selecting module 211 is configured to select reads having an overlap with one end of the first contig close to the gap as a set of reads for gap closing; the second selecting module 212 is configured to select reads having a shortest overlap with the first contig in the set of reads for gap closing as the candidate read; a first determining module 213 is configured to determine whether reads having an overlapping length with the first contig shorter than an overlapping length between the candidate read and the first contig present in the set of reads for gap closing, and whether reads having no overlapping relationship with the candidate read present in the set of reads for gap closing; the second determining module 214 is configured to obtain a result of presenting an extension conflict, and determine an unconfident candidate read, if the first determining module 213 determines that reads having an overlapping length with the first contig shorter than an overlapping length between the candidate read and the first contig present in the set of reads for gap closing, or reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing, obtains the result of presenting the extension conflict, and determines that the candidate read is unconfident; the third selecting module 215 is configured to reselect the candidate read until a confident candidate read is obtained, if the second determining module 214 determines that the candidate read is unconfident; the connecting module 216 is configured to connect the confident candidate read to the first contig, to form a new first contig; the third determining module 217 is configured to determine whether one end of the new first contig close to the gap has an overlap with one end of the second contig close to the gap; the cyclic module 218 is configured to perform a function of the first selecting module 211 again on the basis of the new first contig, if the third determining module 217 determines that one end of the new first contig close to the gap has no overlap with the one end of the second contig close to the gap, in which the first contig in the first selecting module is replaced with the new first contig; the gap closing module 219 is configured to connecting the new first contig to the second contig to complete gap closing, if the third determining module 217 determines that one end of the new first contig close to the gap has an overlap with one end of the second contig close to the gap.

The fourth determining module 220 is configured to determine whether the confident candidate read is the same read with the candidate read used in the above-described apparatus; after the third selecting module obtains the confident candidate read; the terminating module 221 is configured to obtain the result of presenting an extension conflict, and terminate operations of the connecting module 216, if the fourth determining module 220 determines that the confident candidate read is the same read with the candidate read used in the above-described apparatus; the first gap reclosing module 222 is configured to perform the first selecting module 211, the second selecting module 212 and the third selecting module 215 on the basis of the second contig, by starting from one end of the second contig, after the terminating module 221 terminates operations of the connecting module 216, in which the first contigs in the first selecting module 211, the second selecting module 212 and the third selecting module 215 are replaced with the second contig.

The first selecting unit 223 is configured to select reads having an overlapping length with the first contig longer than an overlapping length between the unconfident candidate read and the first contig, and shorter than an overlapping length between other reads in the set of reads for gap closing and the first contig as a newly-selected candidate read in the set of reads for gap closing; the first determining unit 224 is configured to determine whether the newly-selected candidate read has a 100% aligning rate to other reads in the set of reads for gap closing, and whether a fault tolerance of alignment is lower than a first threshold, whether an overlapping length with the first contig is longer than a second threshold; the obtaining unit 225 is configured to take the newly-selected candidate read as the confident candidate read, if the first determining unit 224 determines that the newly-selected candidate read has a 100% aligning rate to other reads in the set of reads for gap closing, and a fault tolerance of alignment is lower than a first threshold, an overlapping length with the first contig is longer than a second threshold; the second selecting unit 226 is configured to perform the first selecting unit 223, if the first determining unit 224 determines that the newly-selected candidate read does not have a 100% aligning rate to other reads in the set of reads for gap closing, and a fault tolerance of alignment is not lower than a first threshold, an overlapping length with the first contig is not longer than a second threshold; the second gap reclosing module 227 is configured to successively perform the first selecting module 211, the second selecting module 212 and the third selecting module 215 on the basis of the second contig, by starting from one end of the second contig, if the third selecting module 215 is unable to finally obtain the confident candidate read after reselecting the candidate read, in which the first contigs in the first selecting module 211, the second selecting module 212 and the third selecting module 215 are replaced with the second contig.

The fifth determining module 228 is configured to determine whether the removed amount of reads in the set of reads for gap closing is greater than a third threshold during the extension of the candidate read, after the second selecting module 212 has selected the candidate read; the fourth selecting module 229 is configured to abandon the candidate read by a cyclic setting and reselect the candidate read, namely, configured to perform the second selecting module 212, if the fifth determining module 228 determines that the removed amount of reads in the set of reads for gap closing is greater than a third threshold during the extension of the candidate read.

The second selecting module 212 is also configured to subject the reads for gap closing in the set of reads for gap closing to a short-similar-repeat treatment and identification, namely, configured to select read for gap closing having a longer overlap as the candidate read, when an presence of the short-similar-repeat is identified.

The second selecting module 212 is also configured to subject the reads for gap closing in the set of reads for gap closing to a length filtering, namely, configured to select a short paired-end read within a gap region as the candidate read, select a long single-end read located at both ends of the gap as the candidate read.

The second selecting module 212 is also configured to subject the reads for gap closing in the set of reads for gap closing to a position filtering, namely, configured to calculate a position of the reads for gap closing within the gap region based on paired-end relationship, subject the reads for gap closing to filtering based on the calculated position of the reads for gap closing within the gap region, to select the candidate read.

The second determining unit 230 is configured to determine whether the one end of the new first contig close to the gap prematurely overlaps with the one end of the second contig close to the gap based on a predicting length of the gap; the third selecting unit 231 is configured to perform the second selecting module 212, if the second selecting module 230 determines that one end of the new first contig close to the gap prematurely overlaps with the one end of the second contig close to the gap based on a predicting length of the gap, wherein a non-overlapping read out of the set of reads for gap closing is selected as the candidate read when the second selecting module 212 selects the candidate read.

The gap closing module 219 is also configured to perform a sequence connection, in which the sequence connection comprises: a direct connection between two contigs both without extensions, a connection between the contig without extension and contig with extension; and a connection between two contigs both with extensions. The gap closing module 219 is also configured to subject an accuracy of the sequence connection to a confidence determination during the step of sequence connection during performing the sequence connection, in which: the sequence connection is performed using a first confidence if the first confidence presents;

the sequence connection is performed using a second confidence if the first confidence does not present while the second confidence presents;

the sequence connection is performed using a third confidence if both the first confidence and second confidence do not present while a third confidence presents,

in which

the first confidence refers connected two sequences not only having an overlap which are not repeat, but also supported by a span read;

the second confidence refers two sequences connected by a bridging read, and having no overlap;

the third confidence refers connected two sequences having an overlap, without a support by an evidence.

In the present embodiment, firstly the first selecting module 211 selects reads having an overlap with one end of the first contig close to the gap as a set of reads for gap closing; secondly the second selecting module 212 selects reads having a shortest overlap with the first contig in the set of reads for gap closing as the candidate read. After the candidate read is obtained, the first determining module 213 determines whether reads having an overlapping length with the first contig shorter than an overlapping length between the candidate read and the first contig present in the set of reads for gap closing, and whether reads having no overlapping relationship with the candidate read present in the set of reads for gap closing; if the first determining module 213 determines that reads having an overlapping length with the first contig shorter than an overlapping length between the candidate read and the first contig present in the set of reads for gap closing, or reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing, an result of presenting an extension conflict is obtained, and the second determining module 214 determines that such candidate read is unconfident. If such candidate read is unconfident, the third selecting module 215 reselects the candidate read until a confident candidate read is obtained. The connecting module 216 connects the confident candidate read to the first contig, to form a new first contig, the third determining module 217 determines whether one end of the new first contig close to the gap has an overlap with one end of the second contig close to the gap, if one end of the new first contig close to the gap has no overlap with the one end of the second contig close to the gap, the cyclic module 218 continuously perform a function of the first selecting module 211 on the basis of the new first contig, in which the first contig in the first selecting module is replaced with the new first contig; if one end of the new first contig close to the gap has an overlap with one end of the second contig close to the gap, the gap closing module 219 connects the new first contig to the second contig to complete gap closing.

After the third selecting module 215 has selected the confident candidate read, the fourth determining module 220 determines whether the confident candidate read is the same read with the candidate read used in the previous apparatus; if the confident candidate read is the same read with the candidate read used in the previous apparatus, the result of presenting the extension conflict is obtained, and the terminating module 211 terminates operations of the connecting module 216. After the sequence extension terminates, the first gap reclosing module 222 successively perform the first selecting module 211, the second selecting module 212 and the third selecting module 215 on the basis of the second contig, by starting from one end of the second contig, in which the first contigs in the first selecting module 211, the second selecting module 212 and the third selecting module 215 are replaced with the second contig; if the fourth determining module 220 determines that the confident candidate read is not the same read with the candidate read used previously, operations of the connecting module 216 are performed.

If the second determining module determines that the candidate read is unconfident, to extend gap closing sequence, the third selecting module 215 needs to reselect the candidate read until a confident candidate read is obtained, specific procedures are shown below:

the first selecting unit 223 selects reads having an overlapping length with the first contig longer than an overlapping length between the unconfident candidate read and the first contig, and shorter than an overlapping length between other reads in the set of reads for gap closing and the first contig as a newly-selected candidate read in the set of reads for gap closing; the first determining unit 224 determines whether the newly-selected candidate read has a 100% aligning rate to other reads in the set of reads for gap closing, and whether a fault tolerance of alignment is lower than a first threshold, whether an overlapping length with the first contig is longer than a second threshold; if the first determining unit 224 determines that the newly-selected candidate read has a 100% aligning rate to other reads in the set of reads for gap closing, and a fault tolerance of alignment is lower than a first threshold, an overlapping length with the first contig is longer than a second threshold, the obtaining unit 225 takes the newly-selected candidate read as the confident candidate read; if the first determining unit 224 determines that the newly-selected candidate read does not have a 100% aligning rate to other reads in the set of reads for gap closing, and a fault tolerance of alignment is not lower than a first threshold, an overlapping length with the first contig is not longer than a second threshold, the second selecting unit 226 performs the first selecting unit, to reselect the candidate read. The second gap reclosing module 227 is used for successively performing the first selecting module 211, the second selecting module 212 and the third selecting module 215 on the basis of the second contig, by starting from one end of the second contig, if the third selecting module 215 is unable to finally obtain the confident candidate read after reselecting the candidate read, in which the first contigs in the first selecting module 211, the second selecting module 212 and the third selecting module 215 are replaced with the second contig.

In the present embodiment, after the second selecting module 212 has selected the candidate read, the fifth determining module 228 still needs to determine whether the removed amount of reads in the set of reads for gap closing is greater than a third threshold during the extension of the candidate read. If the fifth determining module 228 determines that the removed amount of reads in the set of reads for gap closing is greater than a third threshold during the extension of the candidate read, the fourth selecting module 229 abandons the candidate read by a cyclic setting and reselect the candidate read, namely, the second selecting module 212 is subjected to performing.

In the present embodiment, the selection of the candidate read is different in accordance with different situations, for example: the second selecting module 212 is also configured to subject the reads for gap closing in the set of reads for gap closing to a short-similar-repeat treatment and identification, namely, configured to select read for gap closing having a longer overlap as the candidate read, when a presence of the short-similar-repeat is identified; the second selecting module 212 is also configured to subject the reads for gap closing in the set of reads for gap closing to a length filtering, namely, configured to select a short paired-end read within a gap region as the candidate read, select a long single-end read located at both ends of the gap as the candidate read; the second selecting module 212 is also configured to subject the reads for gap closing in the set of reads for gap closing to a position filtering, namely, configured to calculate a position of the reads for gap closing within the gap region based on paired-end relationship, subject the reads for gap closing to filtering based on the calculated position of the reads for gap closing within the gap region, to select the candidate read.

During performing the sequence extension, the second determining unit 230 determines whether the one end of the new first contig close to the gap prematurely overlaps with the one end of the second contig close to the gap based on a predicting length of the gap. If the second determining unit 230 determines that one end of the new first contig close to the gap prematurely overlaps with the one end of the second contig close to the gap based on a predicting length of the gap determined, the candidate read needs to be reselected, and the third selecting unit 231 is configured to perform the second selecting module 212, in which a non-overlapping read out of the set of reads for gap closing is selected as the candidate read when the second selecting module 212 selects the candidate read.

During the step of gap closing, the gap closing module 219 is also configured to subject an accuracy of the sequence connection to a confidence determination during the step of sequence connection during performing the sequence connection, in which

the sequencing connection is performed using a first confidence if the first confidence presents;

the sequencing connection is performed using a second confidence if the first confidence does not present while the second confidence presents;

the sequencing connection is performed using a third confidence if both the first confidence and second confidence do not present while a third confidence presents,

in which

the first confidence refers connected two sequences not only having an overlap which are not repeat, but also supported by a span read;

the second confidence refers two sequences connected by a bridging read, and having no overlap;

the third confidence refers connected two sequences having an overlap, without a support by an evidence.

Being different with the prior art, the present disclosure firstly selects reads having an overlap with one end of the first contig close to the gap as a set of reads for gap closing; secondly selects reads having a shortest overlap with the first contig in the set of reads for gap closing as the candidate read. After the candidate read has been selected, if reads having an overlapping length with the first contig shorter than an overlapping length between the candidate read and the first contig present in the set of reads for gap closing, reads having no overlapping relationship with the candidate read present, an extension conflict presents. After the extension conflict has presented, the original candidate read is abandoned and reselected until a confident candidate read is obtained. The confident candidate read is connected to the first contig, to form a new first contig; and whether one end of the new first contig close to the gap has an overlap with one end of the second contig close to the gap is determined; if the one end of the new first contig close to the gap has no overlap with the one end of the second contig close to the gap, the above step of selecting the set of reads for gap closing on the basis of the new first contig is continuously performed back to the beginning again; if one end of the new first contig close to the gap has an overlap with one end of the second contig close to the gap, the new first contig is connected to the second contig to complete gap closing. By the above steps, the present disclosure may effectively identify the extension conflict in the nucleic acid sequence during gap closing, which improves the accuracy of gap closing.

Since the method of gap closing in a nucleic acid sequence is an essential step during gap closing, it is necessary to make a comprehensive description for the gap closing and the process of identifying an extension conflict and determining an confidence of a candidate read during the gap closing.

In embodiments of the present disclosure, a gap level of the gap is determined in accordance with a size of gap and a criteria set by the system, in which the level of the gene sequence gap is divided into: a small gap, a medium gap and a large gap; and the gap is close in accordance with the level of the nucleic acid sequence gap and the corresponding base sequence. The gap is classified according to followings: a gap having a length shorter than 100 bp is defined as the small gap; a gap having a length between 100 bp and 1.5 kb is defined as the medium gap; a gap having a length longer than 1.5 kb is defined as the large gap. Without any doubts, the above described is only one kind of definition with various gap, the size of every gap is explanatory, which cannot be construed to limit the present disclosure.

Regarding the descriptions of the gap closing, please see the reference below.

Firstly, a scaffold formed with gene sequence gap is obtained and analyzed, in which an original scaffold is fragmented to form a contig, an interval between two contigs is known a gap. In embodiments of the present disclosure, by selecting contigs for gap closing, it may accurately obtain a size of the gap, and contigs before and after the gap. In addition, it may also obtain a length of the contig and sequence information thereof, as well as information of gaps before and after the contig.

In specific implementing process, embodiments of the present disclosure also subjects all nucleic acid sequence gaps and contigs to dividing according to a setting by a user, to correspondingly save the correlative contig and read to a relevant folder. For example, if the user sets 4 folders, all nucleic acid sequence gaps and contigs are divided into 4 parts, 4 files are created, the relevant contig and read are saved into the created files in a way of one-to-one correlation. By the above division, every file comprises contigs and reads for gap closing, which may be obtained directly from the corresponding files during performing subsequent step of gap closing. Obviously, by the above division, the original required memory is reduced to a quarter, which saves memory space and decreases a searching time during gap closing, which decrease a consuming time for gap closing.

Then, read for gap closing is selected within a gap region of the nucleic acid sequence, in embodiments of the present disclosure, most of reads for gap closing belong to PE reads, deriving from Solexa sequencing result, the rest of reads for gap closing are long single reads, deriving from Sanger sequencing result.

The PE reads are supportive with each other, which derives from both ends of a certain inserted fragment, while the inserted fragment for gap closing usually has a length of 180 bp, 500 bp and 800 bp respectively. In embodiments of the present disclosure, by a high-depths method, a certain inserted fragment may be retrieved by an overlapping relationship of a plurality PE reads. Thus, for a certain nucleic acid sequence gap, if a read has an overlapping relationship with one end of contig, and a direction of the read is consistent with that of the contig, namely, the read is PE read, then reads having a PE relationship with the read are located within the nucleic acid sequence gap, or located on the contig after the nucleic acid sequence gap, then such nucleic acid sequence gap can be subjected to a treatment of gap closing.

For long read, as the long read has a relative longer length itself, which may stride a nucleic acid sequence gap having a relative shorter gap length, if every base of the long read is confident, a base at each site in the long read may be used to complete an accurate gap closure with the nucleic acid sequence gap having a relative small gap length.

In embodiments of the present disclosure, for every obtained read within the nucleic acid sequence gap, a position relationship between the read and the nucleic acid sequence gap, contig and scaffold which the read belongs to, and sequence information of the read itself.

To guarantee accuracy and rate of the gap closing, in embodiments of the present disclosure, based on the above described level of the nucleic acid sequence gap, the treatment of gap closing specifically comprises: A: a gap closing treatment with the small gap; B: a gap closing treatment with the medium gap; C: a gap closing treatment with the large gap. A gap closing process of every level gap is described below respectively.

A: For small gap, firstly reads located within the small gap is found. All reads within the small gap is found and analyzed. Reads having an overlap with contigs located at both ends of the small gap are found among reads within the gap region; such reads are used to calculate an actual gap length. As such reads fall into the gap region, and have overlap with the contigs located at both ends of the gap, accordingly if those parts of sequence having the overlap with the contigs located at both ends of the gap are removed, the rest of sequence is a sequence within the gap region. Then, such reads may be used to calculate the actual gap length of the gap. A specific method is: every read striding the gap may be used to calculate one gap length, for all such reads, a frequency table is formed then, representing a range of the gap lengths. The formation of the frequency table is attributed to various gap lengths obtained from connection of contig to different reads resulting from possible error. A gap length having the maximum frequency is selected as an actual gap length.

After the actual gap length has been obtained, if the actual gap length is longer than a fourth threshold set by the system, such as 0, it represents that a base of the sequence within the gap region having such gap length may be the true base of the small gap; reads representing such actual gap length may be analyzed by base to determine the base at every site; if the determined actual gap length is shorter than the fourth threshold set by the system, such as 0, it determines that an overlap presents at both ends of contig; then whether the overlap is repeat is further determined, if the overlap is repeat, it determines in a repeat manner; if the overlap is not repeat, the end of the contig is truncated with a length of the overlap.

In specific implementing process, as there is a few numbers of the reads striding the small gap, the confidence of the above described base in the reads for determining the gap length of the small gap will be a restriction to whether such read may be used for gap closing. In the present embodiment, to guarantee the accuracy of the filled sequence within the gap region, other reads falling into without striding the small gap are found and aligned to the read for determining the gap length of the small gap, if the fault tolerance of alignment is less than 3% (usually is 3%), it may determine that every base in the sequence of the read for determining gap length of the small gap falling into the gap region is confident, which can be used for gap closing; if the fault tolerance of alignment is more than 3% (usually is 3%), it may determine that every base in the sequence of the read for determining gap length of the small gap falling into the gap region is unconfident, which needs to be removed, which guarantees the accuracy of the reads filled into the small gap.

In embodiments of the present disclosure, for the small gap, it is not every small gap can find the read for determining the gap length of the small gap, in the case of being unable to find the read for determining the gap length of the small gap, the gap closing treatment with the medium gap according to the embodiments of the present disclosure needs to be used, which may be referred below.

B: For gap closing treatment with the medium gap, specific implementing procedure is shown below:

B1). Identifying based on a repetitive characteristic of a read, which needs picking up all possible blocks from the read within the medium gap region. In an embodiment of the present disclosure, a block is set having a length of 6 bp or 12 bp, in which the block is a pattern, such pattern comprises a certain number of bases, the block slides one base each time. Specifically, assuming that one block comprises X bases, firstly the block is picked up from the first base to the X base; after the first sliding, the block is picked up from the second base to the (X+1) base, the rest can be done in the same manner, by every sliding, the block is moved forward one base, after n times sliding, the block is picked up from the (n+1) base to the (X+n) base.

In specific implementing procedure, to identify a tandem repeat sequence, in an embodiment of the present disclosure, a frequency of the block (block_freq) and a distance of the same block (block_dis) are recorded and analyzed. If under a certain distance block_dis value, a frequency block_freq has a maximal value, while such distance block_dis value is equal to the number of the base in the block, it can be determine that the tandem repeat sequence presents in such sequence.

In addition, in an embodiment of the present disclosure, a pattern of tandem repeat sequence is further deduced according to information obtained from the above described procedure of determining a tandem repeat sequence: namely, if there is only one kind of tandem repeat sequences in the sequence, it may determine as a hyplotype tandem; if there are a plurality of tandem repeat sequences with or without folk, it may determines as a multi-type tandem.

In specific implementing procedure, to identify the tandem repeat sequence, in an embodiment of the present disclosure, a block frequency is recorded, a situation of the repeat sequences within the gap region is determined by calculating an expecting depth of block within the gap region and analyzing a depth distribution within the gap region, if a frequency of the block within the gap region exponentially increased comparing with the expecting depth of the block within the gap region, it may indicate that a tandem repeat sequence presents.

B2). Regarding the calculation of the overlap between reads

The calculation of the overlap comprises: rapidly determining whether a communal kmer present in every read using a Hash method, there may be overlaps in the reads having the communal kmer. The definition of kmer is: a continuous base sequence having a length of k, in a genome, a distribution of kmer closely relates to a size of the genome, an error rate and a rate of heterozygosis, etc. Then, pair of reads which may have an overlap are subjected to alignment using a patterned identification.

In specific implementing procedure, firstly an maximum overlap is set, and such region is divided into a plurality of blocks, and the block is picked up from a forward end of one read, and found within another read, respectively, to determine whether such block can be found, if such block can be found, the overlapping length is obtained by a specific alignment; if such block cannot be found, the block is continuously picked up. For considering the fault tolerance (namely, the number of mis-matched base within the overlap between two reads is allowed with 3 bases), the number of the block may be up-regulated appropriately.

B3). Regarding a method of identifying an extension conflict and determining a confidence of a candidate read,

Such method has been specifically described in an embodiment of the present disclosure shown as FIG. 1, which needs not to be repeated here.

B4). Regarding a treatment of the conflict

Inventors of the present disclosure finds out that during research, there are two reasons leading to the extension conflict: one is that a base error presents in a candidate read, the other presents repeat folk. In an embodiment of the present disclosure based on the above two situations, following strategy are used when selecting the candidate read to avoid conflict presence:

a1). an alignment rate filtering: read having 100% alignment rate can be a candidate read for a sequence extension.

a2). a position filtering: based on paired-end relationship, a position of a read within the gap region is calculated; the read is subjected to a filtering based on the calculated position, which decreases a conflict resulted from long sequence repeat within the gap region. To guarantee the calculation accuracy of position within the gap region, in an embodiment of the present disclosure, a filtering condition is set strictly.

a3). a read length filtering: during reads obtaining, a PE read has a short length, while a single read usually has a relative long length. All single reads having a relative long length have an overlap with one end of the gap. In an embodiment of the present disclosure, a short paired-end read is preferred for the sequence extension within the gap region, and a long single-end read is preferred for the sequence extension at both ends of the gap.

a4). an end filtering: based on a predicting length of the gap, if an extending read prematurely overlaps with the other end, a non-overlapping read is selected, namely, a read is selected, having a position right after the extending read without an overlap and having no conflict with the predicting length of the gap, which guarantees striding the repeat region once. In an embodiment of the present disclosure, the end filtering can only be performed once.

a5). a treatment and identification of a short-similar-repeat

The short-similar-repeat is usually shorter than 50 bp, and has close positions, which will finally lead to a presence of a base deletion in sequence within the nucleic acid sequence gap region. In an embodiment of the present disclosure, when the short-similar-repeat is identified, a read having a relative longer overlap is preferred to be selected as a candidate read for the sequence extension, which may effectively avoid a problem of the short-similar-repeat.

B5) Regarding a sequence connection

The sequencing connection has been detailed described in an embodiment of the present disclosure which is shown in FIG. 1, which needs not to be repeated here.

C: For gap closing treatment with the large gap

It mainly comprises: dividing the large gap into a plurality of the medium gaps, and then subjecting the obtained plurality of the medium gaps to gap closing treatment in accordance with the treatment procedure with the medium gap.

As there is a restriction to the size of the PE read during gap closing, the longest insert fragment supporting the PE read has a length of 800 bp, if the gap has a length longer than 1.5 kb, a length of an overlap between two ends of contigs is removed, there can be no overlapping relationship between two inserted fragments having a length of 800 bp respectively, namely, it is impossible to find a full path to completely fill up the large gap. In an embodiment of the present disclosure, to avoid a blank space probably generated in the PE read, the large gap is divided into a plurality of the medium gap, and then the divided medium gaps are assembled respectively, finally the assembled result is connected, specific description is shown as below:

c1) calculating a position of a read within the gap region in accordance with a PE relationship, arranging the reads in order in accordance with the calculated position of the read within the gap region, determining that a region having a continuous read covered is a section in accordance with the calculated position;

c2) assembling every section in the manner same as the medium gap;

c3) connecting the assembled result of every section, to obtain a sequence of the large gap with the gap region.

The above descriptions are embodiments of the present disclosure, which cannot be construed to limit the present disclosure, and any equivalent structure chances or equivalent process chances based on the specification and figures of the present disclosure, or direct or indirect applications in other relevant technical fields are all included within the scope of the present disclosure.

1. A method of gap closing in a nucleic acid sequence, wherein the nucleic acid sequence comprises:
a first contig at one end of a gap in an unassembled region, and
a second contig at the other end of the gap in the unassembled region, comprising:
selecting reads having an overlap with one end of the first contig close to the gap as a set of reads for gap closing;
selecting reads having a shortest overlap with the first contig in the set of reads for gap closing as a candidate read;
determining whether reads having an overlapping length with the first contig shorter than an overlapping length between the candidate read and the first contig present in the set of reads for gap closing, and determining whether reads having no overlapping relationship with the candidate read present in the set of reads for gap closing;
obtaining a result of presenting an extension conflict, and determining an unconfident candidate read, if reads having an overlapping length with the first contig shorter than an overlapping length between the candidate read and the first contig present in the set of reads for gap closing, reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing;
reselecting the candidate read until obtaining a confident candidate read, if the candidate read is unconfident;
connecting the confident candidate read to the first contig, to form a new first contig;
determining whether one end of the new first contig close to the gap has an overlap with one end of the second contig close to the gap;
performing the step of selecting the set of reads for gap closing on the basis of the new first contig, if the one end of the new first contig close to the gap has no overlap with the one end of the second contig close to the gap, wherein the first contig in the step of selecting the set of reads for gap closing is replaced with the new first contig;
connecting the new first contig to the second contig to complete gap closing, if one end of the new first contig close to the gap has an overlap with one end of the second contig close to the gap.

2. The method of claim 1, after the step of reselecting the candidate read until obtaining a confident candidate read, and prior to the step of connecting the confident candidate read to the first contig to form a new first contig, further comprising:
determining whether the confident candidate read is the same read with the candidate read used in claim 1; and
obtaining the result of presenting an extension conflict, and terminating the step of connecting the confident candidate read to the first contig, if the confident candidate read is the same read with the candidate read used in claim 1.

3. The method of claim 2, after the step of terminating the step of connecting the confident candidate read to the first contig, further comprising:
starting from one end of the second contig, performing the step of selecting reads having an overlap with one end of the second contig close to the gap as a set of reads for gap closing and the step of reselecting the candidate read until obtaining a confident candidate read on the basis of the second contig,
wherein the first contigs both in the step of selecting reads having an overlap with one end of the first contig close to the gap as a set of reads for gap closing and the step of reselecting the candidate read until obtaining a confident candidate read are replaced with the second contig.

4. The method of claim 1, wherein the step of reselecting the candidate read until obtaining a confident candidate read comprises:
selecting reads having an overlapping length with the first contig longer than an overlapping length between the unconfident candidate read and the first contig, and shorter than an overlapping length between other reads in the set of reads for gap closing and the first contig as a newly-selected candidate read in the set of reads for gap closing;
determining whether the newly-selected candidate read has a 100% aligning rate to other reads in the set of reads for gap closing, and whether a fault tolerance of alignment is lower than a first threshold, whether an overlapping length with the first contig is longer than a second threshold;
taking the newly-selected candidate read as the confident candidate read to obtain the confident candidate read, if the newly-selected candidate read has a 100% aligning rate to other reads in the set of reads for gap closing, a fault tolerance of alignment is lower than a first threshold, and an overlapping length with the first contig is longer than a second threshold;
performing the step of selecting reads having an overlapping length with the first contig longer than an overlapping length between the unconfident candidate read and the first contig, and shorter than an overlapping length between other reads in the set of reads for gap closing and the first contig, if the newly-selected candidate read does not have a 100% aligning rate to other reads in the set of reads for gap closing, and a fault tolerance of alignment is not lower than a first threshold, an overlapping length with the first contig is not longer than a second threshold.

5. The method of claim 4, after the step of reselecting the candidate read until obtaining a confident candidate read, further comprising:
starting from one end of the second contig, performing the step of selecting reads having an overlap with one end of the second contig close to the gap as a set of reads for gap closing and the step of reselecting the candidate read until obtaining a confident candidate read on the basis of the second contig, if the confident candidate read is unable to be finally obtained after the step of reselecting the candidate read,
wherein the first contigs both in the step of selecting reads having an overlap with one end of the first contig close to the gap as a set of reads for gap closing and the step of reselecting the candidate read until obtaining an confident candidate read are replaced with the second contig.

6. The method of claim 1, wherein the step of selecting reads having a shortest overlap with the first contig in the set of reads for gap closing as the candidate read comprises:
subjecting the reads for gap closing in the set of reads for gap closing to a short-similar-repeat treatment and identification,
wherein the step of subjecting the reads for gap closing in the set of reads for gap closing to a short-similar-repeat treatment and identification further comprises:
selecting read for gap closing having a longer overlap as the candidate read, when a presence of the short-similar-repeat is identified.

7. The method of claim 1, after the step of selecting reads having a shortest overlap with the first contig in the set of reads for gap closing as the candidate read, further comprising:
determining whether the removed amount of reads in the set of reads for gap closing is greater than a third threshold during the extension of the candidate read;
abandoning the candidate read by a cyclic setting and reselecting the candidate read, if the removed amount of reads in the set of reads for gap closing is greater than a third threshold during the extension of the candidate read,
wherein the steps of abandoning the candidate read by a cyclic setting and reselecting the candidate read further comprise:
performing the step of selecting reads having a shortest overlap with the first contig in the set of reads for gap closing as the candidate read.

8. The method of claim 1, wherein the step of selecting reads having a shortest overlap with the first contig in the set of reads for gap closing as the candidate read comprises:
subjecting the reads for gap closing in the set of reads for gap closing to a length filtering,
wherein the step of subjecting the reads for gap closing in the set of reads for gap closing to a length filtering further comprises:
selecting a short paired-end read within a gap region as the candidate read, selecting a long single-end read located at both ends of the gap as the candidate read.

9. The method of claim 1, wherein the step of selecting reads having a shortest overlap with the first contig in the set of reads for gap closing as the candidate read comprises:
subjecting the reads for gap closing in the set of reads for gap closing to a position filtering,
wherein the step of subjecting the reads for gap closing in the set of reads for gap closing to a position filtering further comprises: calculating a position of the reads for gap closing within the gap region based on paired-end relationship, and
subjecting the reads for gap closing to filtering based on the calculated position of the reads for gap closing within the gap region, to select the candidate read.

10. The method of claim 1, wherein the step of connecting the new first contig to the second contig to complete gap closing, if one end of the new first contig close to the gap has an overlap with one end of the second contig close to the gap comprises:
performing the step of selecting reads having a shortest overlap with the first contig in the set of reads for gap closing as the candidate read, if the one end of the new first contig close to the gap prematurely overlaps with the one end of the second contig close to the gap based on a predicting length of the gap, and
selecting a non-overlapping read out of the set of reads for gap closing as the candidate read in the step of selecting reads having a shortest overlap with the first contig in the set of reads for gap closing as the candidate read.

11. The method of claim 1, wherein the step of connecting the new first contig to the second contig to complete gap closing, if one end of the new first contig close to the gap has an overlap with one end of the second contig close to the gap, comprises:
performing a sequence connection,
wherein the sequence connection comprises:
a direct connection between two contigs both without extensions,
a connection between the contig without extension and contig with extension; and
a connection between two contigs both with extensions.

12. The method of claim 11, before the step of performing a sequence connection, further comprising:
subjecting an accuracy of the sequence connection to a confidence determination during the step of sequence connection, wherein
the sequence connection is performed using a first confidence if the first confidence presents;
the sequence connection is performed using a second confidence if the first confidence does not present while the second confidence presents;
the sequence connection is performed using a third confidence if both the first confidence and second confidence do not present while the third confidence presents;
wherein
the first confidence refers connected two sequences not only having an overlap which are not repeat, but also supported by a span read;
the second confidence refers two sequences connected by a bridging read, and having no overlap;
the third confidence refers connected two sequences having an overlap without a support by an evidence.

13. An apparatus for gap closing in a nucleic acid sequence, comprising:
a first selecting module, configured to select reads having an overlap with one end of the first contig close to the gap as a set of reads for gap closing;
a second selecting module, configured to select reads having a shortest overlap with the first contig in the set of reads for gap closing as a candidate read;
a first determining module, configured to determine whether reads having an overlapping length with the first contig shorter than an overlapping length between the candidate read and the first contig present in the set of reads for gap closing, and whether reads having no overlapping relationship with the candidate read present in the set of reads for gap closing;
a second determining module, configured to obtain a result of presenting an extension conflict, and determine an unconfident candidate read, if the first determining module determines that reads having an overlapping length with the first contig shorter than an overlapping length between the candidate read and the first contig present in the set of reads for gap closing, or reads having no overlapping relationship with the candidate read present in the set of reads for gap closing, or both reads having an overlapping length with the first contig shorter than an overlapping length between the candidate read and the first contig, and reads having no overlapping relationship with the candidate read present in the set of reads for gap closing;
a third selecting module, configured to reselect the candidate read until a confident candidate read is obtained, if the second determining module determines that the candidate read is unconfident;
a connecting module, configured to connect the confident candidate read to the first contig, to form a new first contig;
a third determining module, configured to determine whether one end of the new first contig close to the gap has an overlap with one end of the second contig close to the gap;
a cyclic module, configured to perform a function of the first selecting module again on the basis of the new first contig, if the third determining module determines that one end of the new first contig close to the gap has no overlap with the one end of the second contig close to the gap, wherein the first contig in the first selecting module is replaced with the new first contig;
a gap closing module, configured to connect the new first contig to the second contig to complete gap closing, if the third determining module determines that one end of the new first contig close to the gap has an overlap with one end of the second contig close to the gap.

14. The apparatus of claim 13, further comprising:
a fourth determining module, configured to determine whether the confident candidate read is the same read with the candidate read used in claim 13; after the third selecting module obtains the confident candidate read;
a terminating module, configured to obtain the result of presenting an extension conflict, and terminate operations of the connecting module, if the fourth determining module determines that the confident candidate read is the same read with the candidate read used in claim 13.

15. The apparatus of claim 14, further comprising:
a first gap reclosing module, configured to perform the first selecting module, the second selecting module and the third selecting module on the basis of the second contig, by starting from one end of the second contig, after the terminating module terminates operations of the connecting module, wherein the first contigs in the first selecting module, the second selecting module and the third selecting module are replaced with the second contig.

16. The apparatus of claim 13, wherein the third selecting module comprises:
a first selecting unit, configured to select reads having an overlapping length with the first contig longer than an overlapping length between the unconfident candidate read and the first contig, and shorter than an overlapping length between other reads in the set of reads for gap closing and the first contig as a newly-selected candidate read in the set of reads for gap closing;
a first determining unit, configured to determine whether the newly-selected candidate read has a 100% aligning rate to other reads in the set of reads for gap closing, and whether a fault tolerance of alignment is lower than a first threshold, whether an overlapping length with the first contig is longer than a second threshold;
an obtaining unit, configured to take the newly-selected candidate read as the confident candidate read, if the first determining unit determines that the newly-selected candidate read has a 100% aligning rate to other reads in the set of reads for gap closing, and a fault tolerance of alignment is lower than a first threshold, an overlapping length with the first contig is longer than a second threshold;
a second selecting unit, configured to perform the first selecting unit, if the first determining unit determines that the newly-selected candidate read does not have a 100% aligning rate to other reads in the set of reads for gap closing, and a fault tolerance of alignment is not lower than a first threshold, an overlapping length with the first contig is not longer than a second threshold.

17. The apparatus of claim 16, further comprising:
a second gap reclosing module, configured to successively perform the first selecting module, the second selecting module and the third selecting module on the basis of the second contig, by starting from one end of the second contig, if the third selecting module is unable to finally obtain the confident candidate read after reselecting the candidate read, wherein the first contigs in the first selecting module, the second selecting module and the third selecting module are replaced with the second contig.

18. The apparatus of claim 13, wherein the second selecting module is also configured to subject the reads for gap closing in the set of reads for gap closing to a short-similar-repeat treatment and identification, namely, configured to select read for gap closing having a longer overlap as the candidate read, when a presence of the short-similar-repeat is identified.

19. The apparatus of claim 13, further comprising:
a fifth determining module, configured to determine whether the removed amount of reads in the set of reads for gap closing is greater than a third threshold during the extension of the candidate read, after the second selecting module has selected the candidate read;
a fourth selecting module, configured to abandon the candidate read by a cyclic setting and reselect the candidate read, namely, configured to perform the second selecting module, if the fifth determining module determines that the removed amount of reads in the set of reads for gap closing is greater than a third threshold during the extension of the candidate read.

20. The apparatus of claim 13, wherein the second selecting module is also configured to subject the reads for gap closing in the set of reads for gap closing to a length filtering, namely, configured to select a short paired-end read within a gap region as the candidate read, select a long single-end read located at both ends of the gap as the candidate read.

21. The apparatus of claim 13, wherein the second selecting module is also configured to subject the reads for gap closing in the set of reads for gap closing to a position filtering, namely, configured to calculate a position of the reads for gap closing within the gap region based on paired-end relationship, subject the reads for gap closing to filtering based on the calculated position of the reads for gap closing within the gap region, to select the candidate read.

22. The method of claim 13, wherein the gap closing module comprises:
a second determining unit, configured to determine whether the one end of the new first contig close to the gap prematurely overlaps with the one end of the second contig close to the gap based on a predicting length of the gap;
a third selecting unit, configured to perform the second selecting module, if the second selecting module determines that one end of the new first contig close to the gap prematurely overlaps with the one end of the second contig close to the gap based on the predicting length of the gap determined, wherein a non-overlapping read out of the set of reads for gap closing is selected as the candidate read when the second selecting module selects the candidate read.

23. The apparatus of claim 13, wherein the gap closing module is also configured to perform a sequence connection,
wherein the sequence connection comprises:
a direct connection between two contigs both without extensions,
a connection between the contig without extension and contig with extension; and
a connection between two contigs both with extensions.

24. The apparatus of claim 23, wherein the gap closing module is also configured to subject an accuracy of the sequence connection to a confidence determination during the step of sequence connection during performing the sequence connection, wherein
the sequence connection is performed using a first confidence if the first confidence presents;
the sequence connection is performed using a second confidence if the first confidence does not present while the second confidence presents;
the sequence connection is performed using a third confidence if both the first confidence and second confidence do not present while a third confidence presents,
wherein
the first confidence refers the connected two sequences not only having an overlap which are not repeat, but also supported by a span read;
the second confidence refers the two sequences connected by a bridging read, and having no overlap;
the third confidence refers the connected two sequences having an overlap, without a support by an evidence.
